(19) United States
(12) Patent Application Publication
(10) Pub. No.: US 2023/0027692 A1
(43) Pub. Date: Jan. 26, 2023

(54) RESOURCE GRAPHS FOR INHERENT AND DERIVED RESOURCE ATTRIBUTES

(71) Applicant: Clearwater Analytics, LLC, Boise, ID (US)

(72) Inventors: Michael Scott Ritthaler, Boise, ID (US); Gary Grant Johnson, Eagle, ID (US); Douglas Gregory Hamilton, Boise, ID (US)

(21) Appl. No.: 17/384,538

(22) Filed: Jul. 23, 2021

(51) Int. Cl. G06F 16/2455; G06F 16/901; G06F 16/21

(52) U.S. Cl. CPC G06F 16/24556; G06F 16/9024; G06F 16/219

(57) ABSTRACT

A facility for creating resource graphs based on inherent and derived resource attributes is configured to assist domain experts in the processing and analyses of resource data. The facility obtains input indicating inherent resource attributes and relationships to other the resource attributes. The facility identifies derived resource attributes based on the inherent resource attributes and the relationships to other resource attributes. The facility generates a resource graph based on the derived resource attributes, inherent resource attributes, and the relationships. The facility obtains attributed data from a repository of resource attribute data and evaluates the resource data based on the resource graph and attribute data.

### BACKGROUND

Organizations typically own and manage numerous resources. As part of managing the resources, an organization stores and processes numerous attributes of the resources, such as for resource audit and analysis purposes. Additionally, organizations derive attributes for the resources from other resource attributes.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments to create a resource graph and use the resource graph to evaluate resource data.

FIG. 3 is a display diagram showing a sample resource value definition screen presented by the facility in some embodiments.

FIG. 4 is a display diagram depicting a resource graph used to illustrate how the facility generates resource graphs in some embodiments.

FIG. 5 is a table diagram showing sample contents of a resource attribute data table used by the facility in some embodiments to store information used to define resource attributes.

FIG. 6 is a sample resource graph with resource data that illustrates how the facility evaluates resource data in some embodiments.

FIG. 7 is a flow diagram showing a process performed by the facility in some embodiments to create a resource graph used to perform aggregations.

FIG. 8 is a display diagram showing a sample resource value and tag definition screen presented by the facility in some embodiments.

FIG. 9 is a display diagram depicting a resource graph with aggregation functions which may be generated by the facility in some embodiments.

FIG. 10 is a table diagram showing sample contents of an attribute and tag data table used by the facility in some embodiments to store information used to describe resource attributes and resource tags.

FIG. 11 is a sample resource and aggregation graph with tag data and attribute data that illustrates how the facility uses tags to aggregate resource data in some embodiments.

FIG. 12 is a flow diagram showing a process performed by the facility in some embodiments to perform a push operation.

FIG. 13 is a flow diagram showing a process performed by the facility in some embodiments to perform a pull operation.

FIG. 14 is a flow diagram showing a process performed by the facility in some embodiments to perform a query operation.

FIG. 15 is a flow diagram showing a process performed by the facility in some embodiments to create and use a snapshot of a resource graph.

### DETAILED DESCRIPTION

The inventors have determined that it would be beneficial to allow domain experts to specify calculations for resource analysis, to create graphs representing resource attributes, including inherent attributes and derived attributes (collectively “resource attributes), and to perform aggregations over resource attributes for groups of resources.

Currently, in order to analyze and audit resources based on their attributes, domain experts use a variety of different tools which cannot quickly represent, audit, and analyze the attributes. The inventors have recognized a variety of disadvantages to current methods of representing, auditing, and analyzing resources and their attributes. First, the difficulty of tracing and auditing calculations regarding derived attributes increases as the complexity of the correlations between each attribute of a resource in order to obtain the derived attribute increases. Additionally, snapshots of the resources, their attributes, and derived attributes are locked at the end of each time period that data is collected, such as monthly, weekly, quarterly, etc. These snapshots add to the difficulty of auditing, especially as more snapshots are collected, and as derived attributes for each of the resources changes. Current tools additionally require all attributes captured in a snapshot to be recalculated when new data for the time period is collected. These tools also require calculations to be batch processed when new data is obtained instead of targeting and performing only the calculations related to the new data.

In response to recognizing these disadvantages, the inventors have conceived and reduced to practice a software and/or hardware facility for representing, auditing, and analyzing resources and their attributes by creating a graph which uses a variety of update schemes to determine the derived attributes of a resource (“the facility”). The facility enables a domain expert (a “user”) to create a graph representing a resource's attributes and each attribute's relationship to the resource's derived attributes. The facility additionally performs and defines calculations based on resource attributes, and allows a user to audit the data generated by the calculations at any time. Additionally, the facility utilizes a graph to perform aggregations over resource attributes based on resource groups defined by tags.

In some embodiments the facility displays a user interface which allows a user to define a resource's attributes. In some embodiments, the user interface additionally allows a user to define derived attributes by describing relationships to other resource attributes. In some embodiments, the user defines the inherent attributes and the derived attributes by using a programming language designed to define and manipulate resource attributes. In some embodiments, the facility uses the definition of resource attributes to create a graph representing a resource's attributes, derived attributes, and the relationships to the other attributes. In some embodiments, the graph is used to perform aggregations on attributes for one or more resources. In some embodiments, the facility creates the graph and performs the aggregations by using tags assigned to each of the resources.

In some embodiments, groups of resources are defined through the use of tags and tag sets. A tag set includes information describing one or more tags related to a resource. The facility utilizes the tag set and resource attributes to aggregate data for groups of resources. In some embodiments, the facility generates this data by performing calculations for attributes of resources which have the same tag. In some embodiments, the facility obtains a set of values representing a portion of the resource attributes from a repository of resource values (a “fact store”). In some embodiments, the fact store includes values for resource attributes at the time the values were obtained, derived, calculated, etc. In some embodiments, the facility obtains the set of values via user input.

In some embodiments, the facility makes available alternative graph update schemes, such as push, pull, query, etc., along with tag sets and resource attributes to audit or analyze resources. In some embodiments, a push update scheme allows a user to specify a value for a resource attribute. In some embodiments, the facility re-evaluates each derived attribute for the resource during a push update scheme. In some embodiments, the facility does not derive each attribute during a push update scheme, and simply adjusts the value of the resource attribute. In some embodiments, a pull update scheme causes a recalculation for each of a resource's attributes. In some embodiments, a query update scheme allows a user to obtain the value of a specified attribute. In some embodiments, when performing a query update scheme, the facility re-evaluates only the resource attributes necessary to obtain a specified resource attribute.

In some embodiments, the facility provides aggregation functions, such as mean, median, mode, count, max, min, shift, etc. In some embodiments, the aggregation functions can be used in conjunction with tag sets to aggregate one or more attributes of one or more resources.

In some embodiments, the facility periodically stores a snapshot of a graph representing the resource attributes and tag set, and/or stores each updated value of a resource attribute as it is determined. In some embodiments, the facility uses this stored data to audit or analyze the resources. In some embodiments, the facility uses the fact store in addition to the snapshots to audit or analyze the resources. In some embodiments, the facility uses the fact store to obtain historical data for use in conjunction with the snapshot to audit or analyze resources.

By performing in some or all of the ways described above, the facility allows a user to quickly create a graph for representing and deriving resource attributes, and use the graph to audit and analyze the resources.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by delaying derivation of a derived resource attribute when another attribute is updated until the derivation is necessary, or requested by a user, the facility conserves processing power, electricity, and memory by updating the attributes only when necessary. As another example, the facility is able to utilize the graph, resource attributes, derived attributes, and tag sets stored in the snapshots to recreate the state of an organization's resources in a way which uses less processing power, electricity, and memory than current tools.

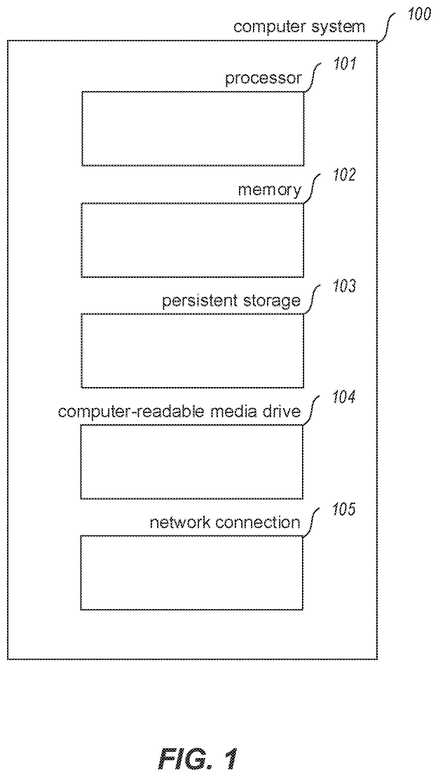

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

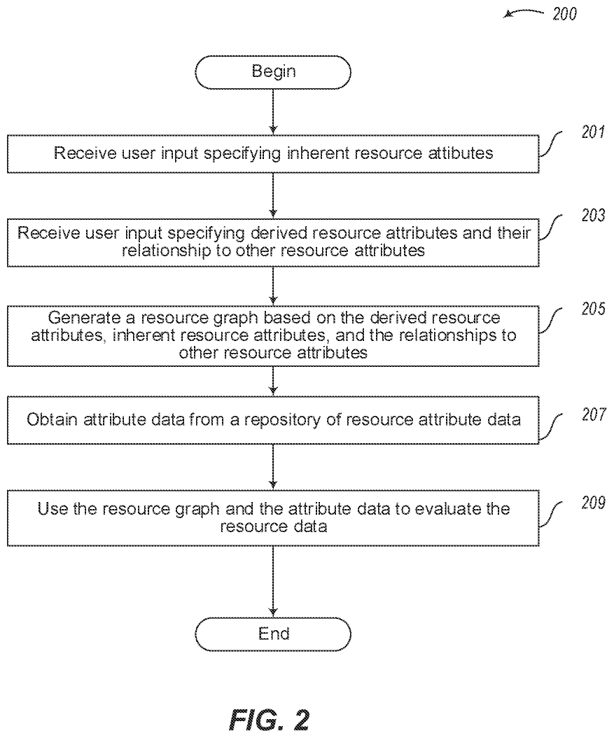

FIG. 2 is a flow diagram showing a process performed by the facility in some embodiments to create a resource graph and use the resource graph to evaluate resource data 200. At act 201, the facility receives user input specifying inherent resource attributes. At act 203, the facility receives user input specifying derived attributes and their relationship to other resource attributes. In some embodiments, the facility uses a coding language to obtain the user input specifying inherent resource attributes, derived resource attributes, the relationships to other resource attributes, or any combination of the three.

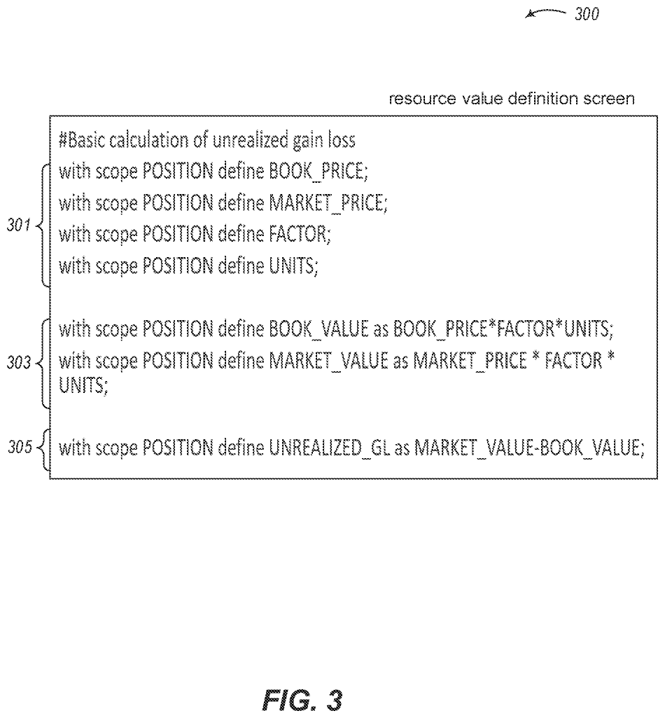

FIG. 3 is a display diagram showing a sample resource value definition screen 300 presented by the facility in some embodiments. The resource value definition screen 300 obtains user input used to define resource attributes. The sample resource value definition screen 300 depicted in FIG. 3 contains sample input used to define attributes for determining the unrealized gain and loss of a resource. The resource value definition screen 300 includes inherent attribute definitions 301, derived attribute definitions 303, and unrealized gain loss definition 305.

The inherent attribute definitions 301 indicate inherent attributes for the resource. For example, in the sample input, the inherent attribute “BOOK_PRICE” is defined by the line: “with scope POSITION define BOOK_PRICE;”. The facility identifies where the “define” command is located, and uses that location to recognize that a new attribute called “BOOK_PRICE” is defined.

The derived attribute definitions 303 indicate defined derived attributes for the resource. For example, in the sample input, the derived attribute “BOOK VALUE” and it's relationships to other attributes are defined by the line: “with scope POSITION define BOOK VALUE as BOOK_PRICE*FACTOR*UNITS;”. The input indicates to the facility that a new attribute called “BOOK VALUE” is defined. Additionally, the “as” command indicates that the attribute has a relationship with one or more other attributes. In some embodiments, the relationship is be defined by a mathematical relationship, such as “BOOK_PRICE*FACTOR*UNITS”, which indicates that each of the attributes (that is, BOOK_PRICE, FACTOR, and UNITS) are multiplied together. Other mathematical operators, such as addition, subtraction, division, exponents, etc. may be used to define a relationship between attributes. In some embodiments, mathematical functions may be used to define relationships between attributes.

The unrealized gain loss definition 305 provides an example where a derived attribute is defined based on its relationship with other derived attributes. For example, the “UNREALIZED_GL” is defined as the “MARKET_VALUE-BOOK_VALUE”, that is, by subtracting the “BOOK VALUE” from the “MARKET_VALUE”. In some embodiments, any number of inherent or derived attributes may be used to define the relationships between attributes. Returning to FIG. 2, at act 205, the facility generates a resource graph based on the inherent attributes, derived attributes, and the relationship between attributes obtained in acts 201 and 203.

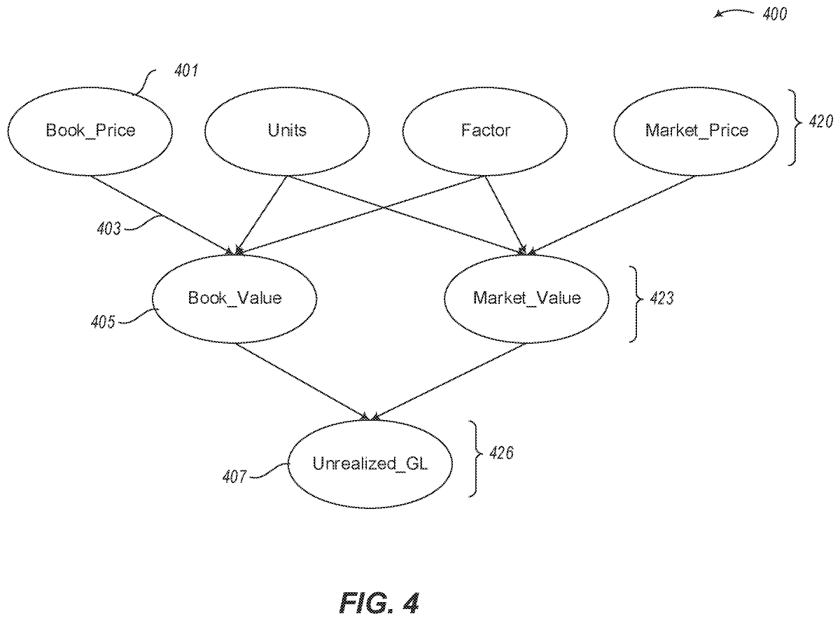

FIG. 4 is a display diagram depicting a resource graph 400 used to illustrate how the facility generates resource graphs in some embodiments. The resource graph 400 is a human-readable depiction of a data structure for a resource graph which is generated by the facility. The resource graph 400 includes a book_price attribute 401, a book_value attribute 405, an unrealized_gl attribute 407, and one or more connectors 403. Additionally, the resource graph 400 includes an inherent attribute layer 420, a first derived attribute layer 423, and a second derived attribute layer 426. The attributes seen in the inherent attribute layer 420, such as the book_price attribute 401, are each inherent attributes for the resource. The attributes in the first derived attribute layer 423 and second derived attribute layer 426, such as the book_value attribute 405 and unrealized_gl attribute 407 respectively, are each derived attributes. The connector 403 is used to visually depict the relationship between each of the attributes. For example, the connector 403 indicates that the book_price 401 is used to define the book_value attribute 405.

Returning to FIG. 2, at act 207, the facility obtains attribute data from a repository of resource attribute data. At act 209 the facility uses the resource graph and the attribute data to evaluate the resource data. After act 209 the process ends.

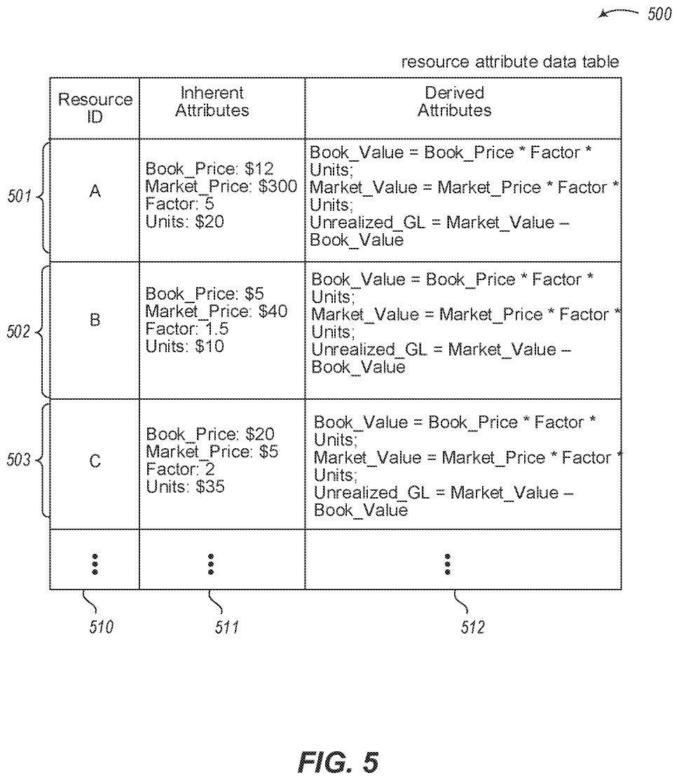

FIG. 5 is a table diagram showing sample contents of a resource attribute data table 500 used by the facility in some embodiments to store information used to define resource attributes. In the sample resource attribute data table 500, rows 501-503 each represent resource data including the inherent attributes and derived attributes each resource has. The rows are divided into a resource id column 510, an inherent attributes column 511, and a derived attributes column 512. The resource id column 510 includes information indicating an identifier for a resource. The inherent attributes column 511 includes information indicating one or more inherent attributes, and their values, for a resource. In some embodiments, the inherent attributes column 511 does not include the values for the attributes. In some embodiments, the values for each inherent attribute of a resource are stored in a separate table, data structure, etc. In some embodiments, the values for each inherent attribute are stored in a fact store. In some embodiments, previous values for inherent attributes are stored in the fact store. In some embodiments, the facility stores the previous value when a value for the inherent attribute has been updated. In some embodiments, the facility periodically stores the current value of an inherent attribute as a previous value of the attribute. The derived attributes column 512 includes information indicating one or more derived attributes, and their relationship to other attributes, for a resource. In some embodiments, the derived attributes column 512 does not include the relationships to other attributes. In some embodiments, the relationships to other attributes are stored in a separate table, data structure, etc. from the resource attribute data table 500. In some embodiments, a value for each derived attribute is stored in a fact store. In some embodiments, previous values for derived attributes are stored in the fact store. In some embodiments, the facility stores the previous value when a value for the derived attribute has been updated. In some embodiments, the facility periodically stores the current value of a derived attribute as a previous value.

For example, row 501 indicates that resource “A” has four inherent attributes: “Book_Price”, “Market_Price”, “Factor, and “Units”. Furthermore, resource “a” has three derived attributes: “Book_Value”, “Market_Value”, and “Unrealized_GL”. As can be seen in row 301, the derived attributes “Book_Value” and “Market_Value” each are derived based on their relationship to inherent attributes. For example, the “Book_Value” is defined as the “Book_Price” multiplied by the “Factor”, and further multiplied by the “Units”. Therefore, to obtain the “Book_Value”, the “Book_Price” is multiplied by the “Factor” and the “Units”. Furthermore, the derived attributes can be derived based on their relationship with other derived attributes, such as the “Unrealized_GL” being defined as the “Market_Value” minus the “Book_Value”. As can be seen, a derived attribute can be defined based on its relationship with any number of inherent attributes, derived attributes, or combinations of inherent and derived attributes.

While FIG. 5 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

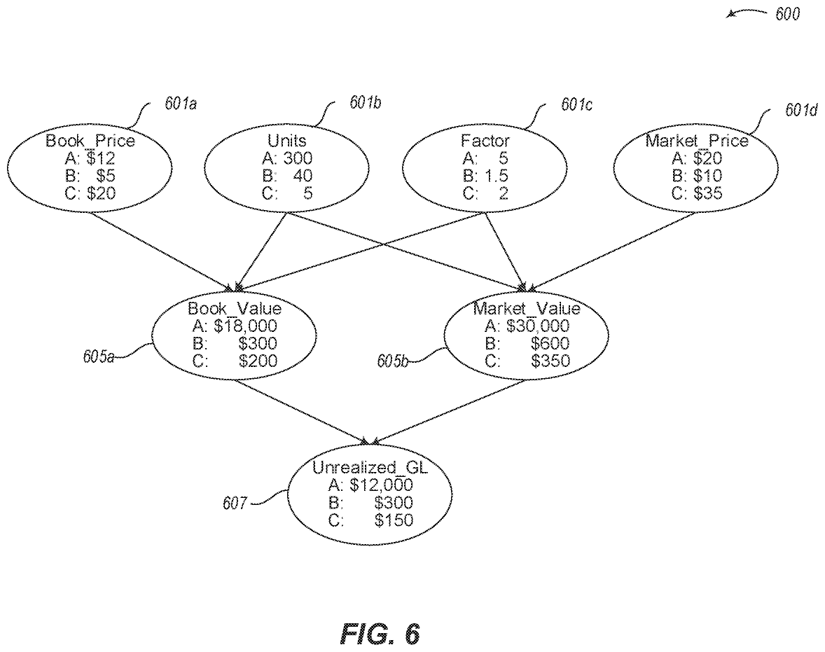

FIG. 6 is a sample resource graph with resource data 600 used to illustrate how the facility evaluates resource data in some embodiments. The resource graph with resource data 600 is used as an example to illustrate how the facility uses the resource graph to evaluate the resource data. The resource graph with resource data 600 includes inherent attributes 601a-601d, first derived attributes 605a and 605b, and a second derived attribute 607.

For example, the facility obtains resource attribute data for each inherent attribute of the resource, in this case the “Book_Price”, “Units”, “Factor”, and “Market_Price” indicated by the inherent attributes 601a-601d. The facility then uses the resource attribute data to evaluate the rest of the resource's derived attributes, such as the first derived attributes 605a and 605b, and the second derived attribute 607. As an example, resource “A” may have a Book_Price of $12, 300 units, a factor of 5, and a Market_Price of $20, as indicated by the inherent attributes 601a-601d. The facility calculates the Book_Value of resource “A” by using the Book_Price, units, and factor to obtain a value of $18,000. The facility calculates the Market_Value of resource “A” by using the units, factor, and Market_Price to obtain a value of $30,000. The facility calculates the Unrealized_GL of resource “A” by subtracting the Market_Value from the Book_Value to obtain a value of $12,000.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

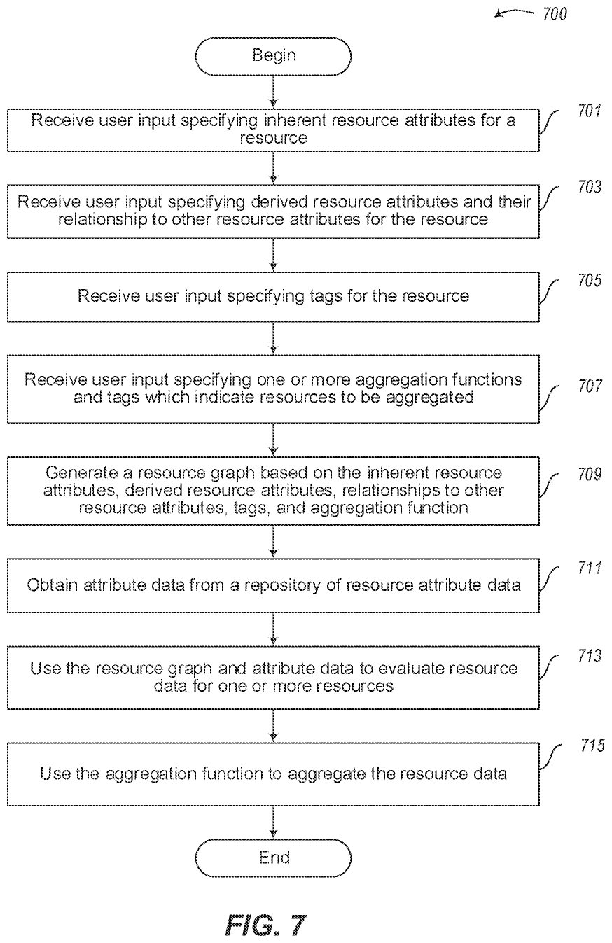

FIG. 7 is a flow diagram showing a process performed by the facility in some embodiments to create a resource graph used to perform aggregations 700. At act 701, the facility receives user input specifying inherent resource attributes for a resource. At act 703, the facility receives user input specifying derived resource attributes and their relationship to other resource attributes for the resource. In some embodiments, the facility performs acts 701 and 703 in a similar manner to acts 201 and 203 of FIG. 2. At act 705, the facility receives user input specifying tags for the resource. At act 707, the facility receives user input specifying one or more aggregation functions and tags which indicate resources to be aggregated. In some embodiments, the facility uses a specialized coding language to obtain user input in one or more of acts 701-707.

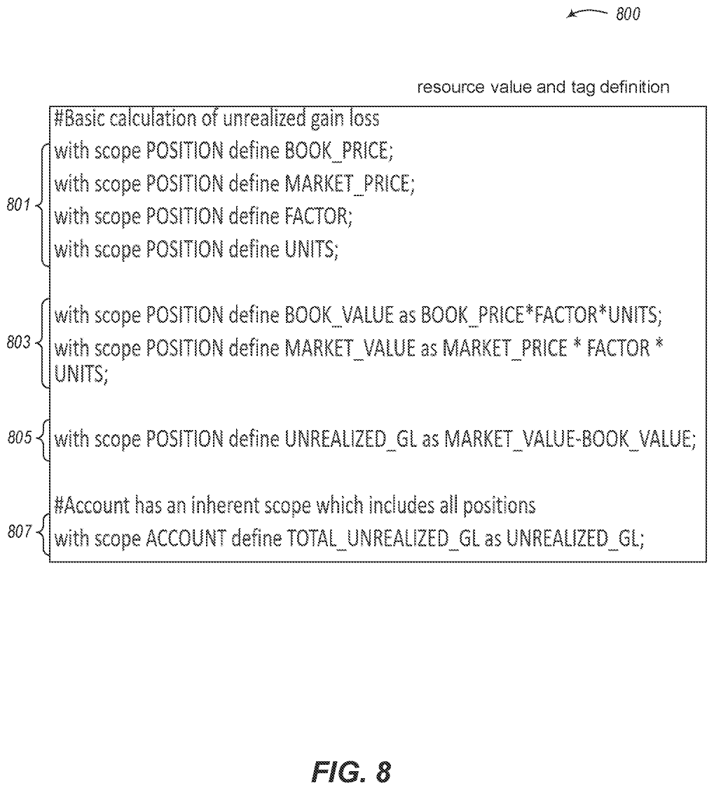

FIG. 8 is a display diagram showing a sample resource value and tag definition screen 800 presented by the facility in some embodiments. The resource value and tag definition screen 800 is similar to the resource value definition screen 300, however, the resource value and tag definition screen 800 includes input regarding tags for each resource as well as an aggregation function. The resource value and tag definition screen 800 includes an inherent attributes section 801, a first derived attributes section 803, a second derived attributes section 805, and an aggregation section 807.

The inherent attributes section 801 indicate inherent attributes, and a tag or tag set for the attribute. The inherent attributes are defined in a similar manner to the inherent attributes of FIG. 3. The tag, or tag set, of the attribute are defined based on the input appearing after “scope” in the inherent attribute section 801. For example, in the resource value and tag definition screen 800, the “BOOK_PRICE” is defined with a scope “POSITION”. Thus, the BOOK_PRICE is defined as an attribute of resources belonging to the POSITION tag set. The process of assigning a tag or tag set is similar for derived attributes, as can be seen in the first derived attribute 803 and second derived attribute 805. In this way, each resource with a “POSITION” tag has the defined attributes, such as BOOK_PRICE, BOOK_VALUE, UNREALIZED_GL, etc.

The aggregation section 807 defines an aggregation of resource attributes based on the resource's tag or tag set. In some embodiments, the facility performs aggregations for all resources with a certain tag set. For example, in FIG. 8, the ACCOUNT tag set is a tag set for resources representing an entire account, and includes all of the resources which belong to the POSITIONS tag set. In this way, the ACCOUNT tag set is akin to a “parent tag” with the POSITIONS tag set being a “child tag” of the ACCOUNT tag set. Thus, to obtain the total unrealized gain and loss for an account, a user would obtain a sum of the unrealized gain and loss for each position within the account. In order to obtain the total unrealized gain and loss for an account, a user would input “with scope ACCOUNT define TOTAL_UNREALIZED_GL as UNREALIZED_GL”. Thus, because “UNREALIZED_GL” is an attribute of resources with the tag set POSITION, and because an ACCOUNT includes multiple positions, the facility is instructed to obtain each UNREALIZED_GL for the positions within the account and aggregate them to obtain the TOTAL_UNREALIZED_GL for the account. In some embodiments, when an aggregation function is not specified, the facility uses a default aggregation function, such as a sum, mean, median, max, etc. In some embodiments, an aggregation function is specified in the aggregation section 807. In some embodiments, the facility is able to perform aggregation functions including one or more of: mean, median, mode, count, max, min, shift, etc. In some embodiments, multiple aggregations are defined in the aggregation section 807. As described above, in this way each resource with the “ACCOUNT” tag has a TOTAL_UNREALIZED_GL attribute.

Returning to FIG. 7, at act 709, the facility generates a resource graph based on the inherent resource attributes, derived resource attributes, relationships to other resource attributes, tags, and the one or more aggregation functions.

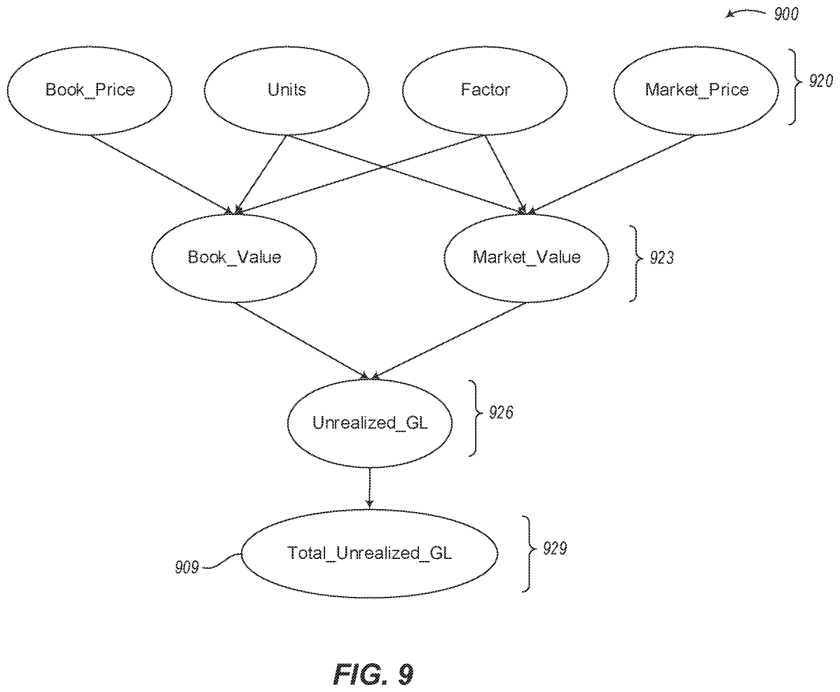

FIG. 9 is a display diagram depicting a resource graph with aggregation functions 900 which may be generated by the facility in some embodiments. Like the resource graph 400, the resource graph with aggregation functions 900 is a human-readable depiction of a resource graph generated by the facility, however the facility may generate a graph represented by code, data, or other machine-readable representations. The resource graph with aggregation functions 900 includes an inherent attribute layer 920, a first derived attribute layer 923, a second derived attribute layer 926, an aggregation layer 929, and an aggregation block 909. The inherent attribute layer 920, first derived attribute layer 923, and second derived attribute layer 926 are similar to the inherent attribute layer 420, first derived attribute layer 423, and second derived attribute layer 426, respectively. The aggregation layer 929 includes all of the aggregation blocks generated in the resource graph. The aggregation block 909 represents the aggregation function obtained in act 707.

Returning to FIG. 7, at act 711, the facility obtains attribute data from a repository of resource attribute data. At act 713, the facility uses the resource graph and attribute data to evaluate resource data for one or more resources. In some embodiments, acts 711 and 713 are performed in a similar manner to acts 207 and 209 in FIG. 2. At act 715, the facility uses the aggregation function to aggregate the resource data for each of the resource evaluated in act 713. In some embodiments, the facility causes the aggregated resource data to be displayed to a user. After act 715, the process ends.

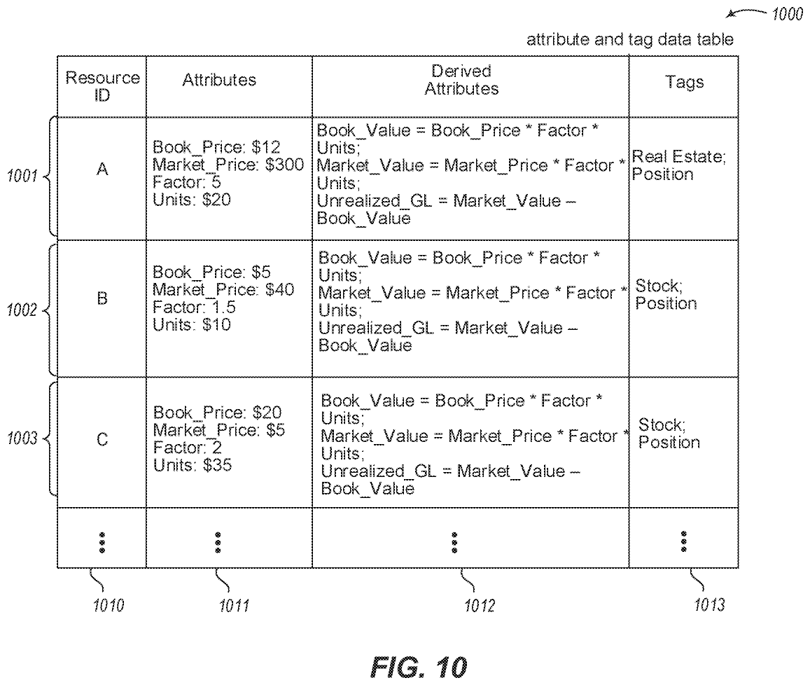

FIG. 10 is a table diagram showing sample contents of an attribute and tag data table 1000 used by the facility in some embodiments to store information used to describe resource attributes and resource tags. In the sample attribute and tag data table 1000, rows 1001-1003 each represent resource attribute data and tag data describing the attributes each resource has and which tags are used to identify the resource. The rows are divided into a resource id column 1010, an inherent attributes column 1011, a derived attributes column 1012, and a tags column 1013. The resource id column 1010, inherent attributes column 1011, and derived attributes column 1012 are similar to the resource id column 510, inherent attributes column 511, and derived attributes column 512 of FIG. 5, respectively. The tags column 1013 includes information specifying tags for a resource. In some embodiments, the facility uses tags to identify a resource, its type, other similar resources, etc.

For example, in row 1001, the tag column 1013 indicates that resource “A” includes the “Real Estate” tag and “Position” tag. Likewise, in row 1002, the tag column 1013 indicates that resource “B” includes the “Stock” tag and “Position” tag. Thus, based on the sample data in the attribute and tag data table 1000, when the facility searches for resources with a “Real Estate” tag, the facility would obtain resource “A”. Additionally, when the facility searches for resources with a “Stock” tag, the facility would obtain resources “B” and “C”, but not resource “A”. Furthermore, when the facility searches for resources with a “Position” tag, the facility obtains resources “A”, “B”, and “C”. In some embodiments, the facility uses the tags to perform aggregations on multiple resources, a class of resources, etc. In some embodiments, the tags indicated in the tag column 1013 represent one or more other tags as a “tag set”. In some embodiments, the tags indicated in the tag column 1013 can be a parent tag or a child tag.

In some embodiments, a parent tag has one or more child tags, such that a resource with the parent tag includes resources with the child tag. For example, an “Investments” tag may be a parent tag with child tags including tags such as “Stock”, “Real Estate”, “Bond”, etc. A resource with an “Investments” tag would then include resources which have “Stock”, “Real Estate”, “Bond”, etc. tags (similar to the “Account” tag described in connection with FIG. 8). The facility is able to use the “Investments” tag to obtain every resource which includes the “Stock”, “Real Estate”, “Bond”, etc., tags. Thus, in this example, when identifying resources with the “Investments” tag, the facility obtains resources which are stocks, bonds, real estate, etc. Likewise, when the facility identifies resources with the “Stock” tag, resources representing other investments, such as real estate and bonds, are not included.

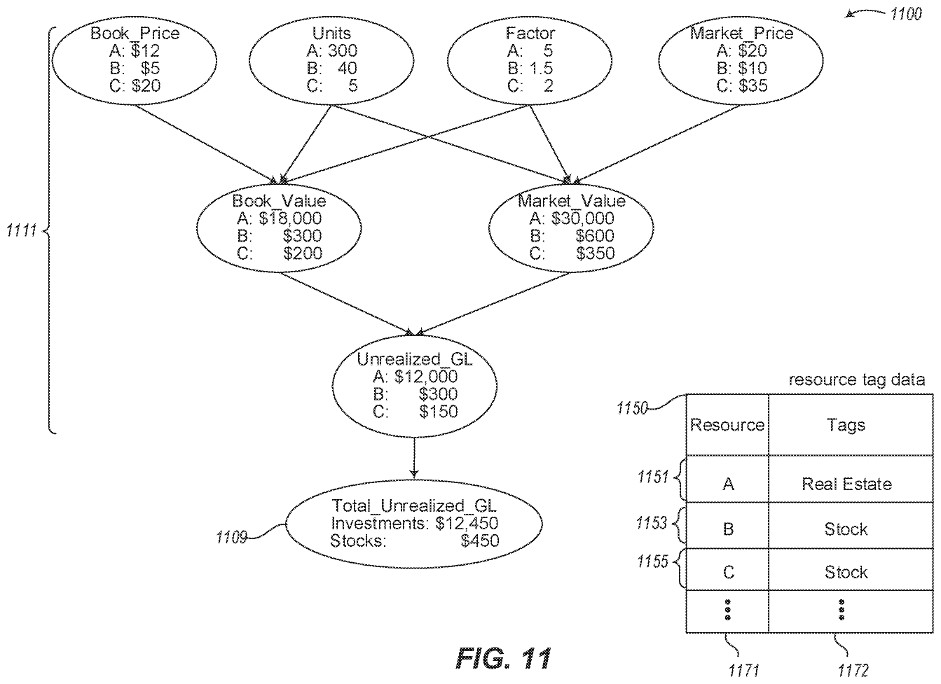

FIG. 11 is a sample resource and aggregation graph with tag data and attribute data 1100 used to illustrate how the facility uses tags to aggregate resource data in some embodiments. The top section 1111 of the resource and aggregation graph with tag data and attribute data 1100 is similar to the resource graph with resource data 600 of FIG. 6. The resource and aggregation graph with tag data and attribute data 1100 additionally includes an aggregated data block 1109, and a resource tag data table 1150. The resource tag data table 1150 includes sample data describing tags for each resource depicted in FIG. 11. The resource tag data table 1150 includes rows 1151-1153, which are split into two columns: a resource column 1171 and a tags column 1172. The resource column 1171 includes information identifying a resource. The tags column 1172 includes information identifying tags for the resource. Row 1151 includes data representing resource A. The tag for resource A is “Real Estate”, which indicates that resource A has the “Real Estate” tag. As indicated by rows 1152 and 1153, resources B and C have the “Stock” tag.

In FIG. 11, an “Investments” parent tag includes all resources which are investments, such as “Real Estate” and “Stock”. Additionally, a “Stocks” parent tag includes all resources which are “Stock”. As a result, when the facility aggregates the resources with the “Investments” tag, the “Total_Unrealized_GL” is $12,450 because all three resources have tags which are child tags of the “Investments” tag, as can be seen in the aggregation block 1109. Likewise, when the facility aggregates resources with the “Stocks” tag, the “Total_Unrealized_GL” is $450 because only resources B and C have tags which are child tags of the “Stocks” tag, as can be seen in the aggregation block 1109.

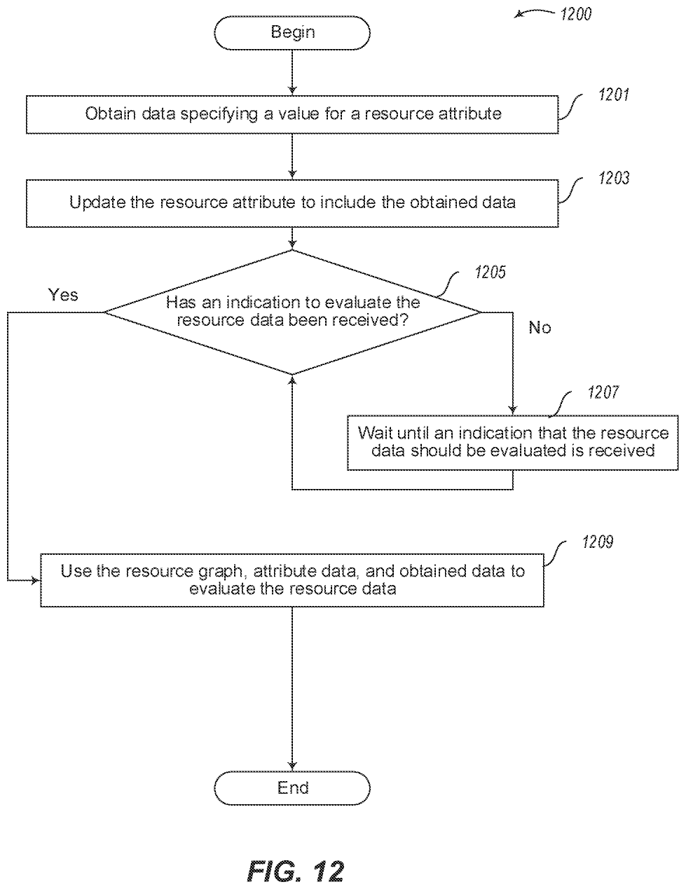

FIG. 12 is a flow diagram showing a process performed by the facility in some embodiments to perform a push operation 1200. At act 1201, the facility obtains data specifying a value for a resource attribute. In some embodiments, the facility additionally obtains an indication to evaluate the resource data at act 1201. At act 1203, the facility updates the resource attribute to include the obtained data. At act 1205, the facility determines whether it has reserved an indication to evaluate the resource data. If the facility has not received such an indication, the process continues to act 1207, otherwise the process continues to act 1209. At act 1207, the facility waits until an indication that the resource data should be evaluated is received, and the process returns to act 1205. In some embodiments, when the facility performs another operation, such as a query operation, pull operation, etc., the facility continues to act 1209 as if the indication to evaluate the resource data has been received. At act 1209, the facility uses the resource graph, attribute data and obtained data to evaluate the resource data, and update the values of each of the resources attributes based on the value for the resource attribute which was received. After act 1209, the process to perform a push operation ends.

For example, and with regard to the attribute and tag data table 1000, the facility may receive data specifying that the Book_Price of resource A should be updated to $15 from $12, as well as an indication that the other resource attributes should not be updated when the value is changed. The facility would update the Book_Price to $15, but would not update the Book_Value or Unrealized_GL for resource A based on the new Book_Price until it receives an indication that these attributes should be updated, such as by receiving a command that the attributes should be updated, or a command to perform another operation, such as a pull or query operation which requests or requires the Book_Value or Unrealized_GL. Furthermore, the facility would not update any aggregation functions which use the Book_Price, Book_Value, or Unrealized_GL until it receives such an indication.

In some embodiments, the facility only updates the resource attributes required to obtain the data requested or required by the other operation. For example, if only the Book_Value is requested in the above example, the facility would update the Book_Value, but not the Unrealized_GL or aggregation functions which use the Book_Value. Thus the facility is able to perform only necessary calculations when a value for a resource attribute is updated, which allows the facility to conserve computing resources which would have otherwise been used to update every attribute and aggregation which uses the Book_Price.

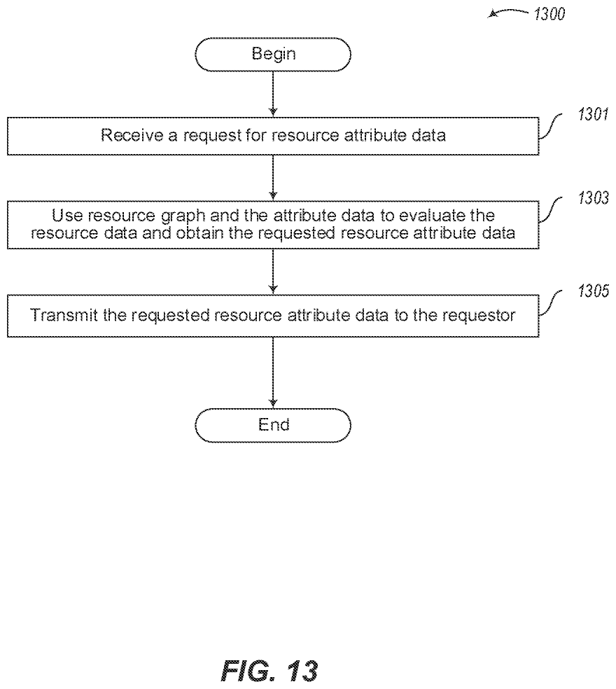

FIG. 13 is a flow diagram showing a process performed by the facility in some embodiments to perform a pull operation 1300. At act 1301, the facility receives a request for resource attribute data. At act 1303, the facility identifies the resource graph needed to obtain the resource attribute data and uses the resource graph and attribute data to evaluate the resource data and obtain the requested resource attribute data. At act 1305, the facility causes the requested resource attribute data to be transmitted to the requestor. In some embodiments, the facility re-evaluates the resource data for every resource attribute in the resource graph as part of performing the pull operation. After act 1305, the process to perform a pull operation ends.

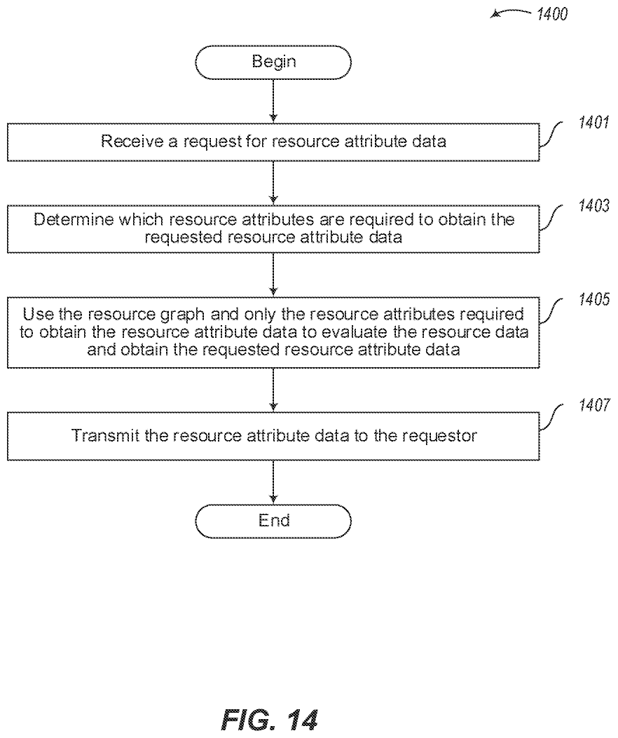

FIG. 14 is a flow diagram showing a process performed by the facility in some embodiments to perform a query operation 1400. At act 1401, the facility receives a request for resource attribute data. At act 1403, the facility determines which resource attributes are required to obtain the requested resource attribute data. At act 1405, the facility uses the resource graph and the resource attributes required to obtain the requested resource attribute data to evaluate the resource data and obtain the requested resource attribute data. At act 1407, the facility transmits the resource attribute data to the requestor. In this way, the facility is able to obtain the requested data while limiting any unnecessary operations, which conserves computing resources that the facility would otherwise have used to perform the unnecessary operations. After act 1407, the process to perform a query operation ends.

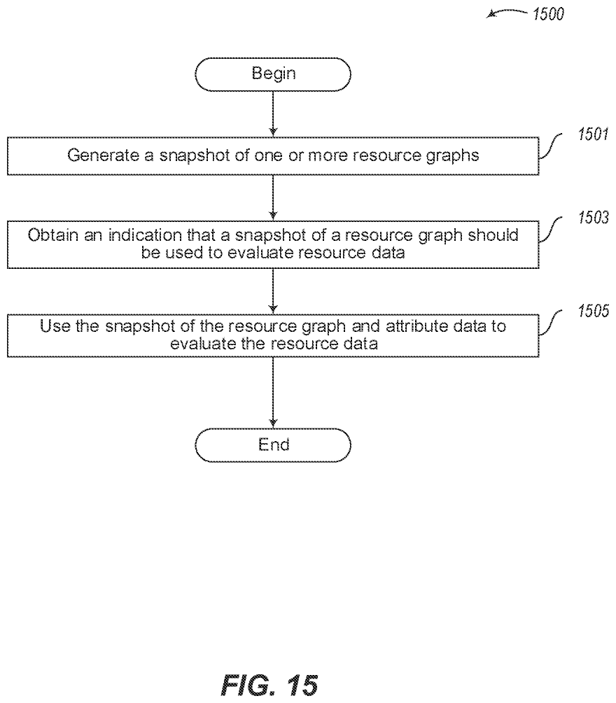

FIG. 15 is a flow diagram showing a process performed by the facility in some embodiments to create and use a snapshot of a resource graph 1500. At act 1501, the facility generates a snapshot of one or more resource graphs representing the attributes and relationships between attributes for a resource. In some embodiments, the snapshot generated by the facility in act 1501 is a snapshot of the values of one or more resource attributes, or a “value history”. In some embodiments, the snapshot includes the attributes and relationships between attributes for a resource, as well as the value history for the resource. In some embodiments, the facility generates snapshots of the resource graphs periodically. In some embodiments, the facility generates the snapshots after receiving an indication that the snapshot should be generated.

At act 1503, the facility obtains an indication that a snapshot of a resource graph should be used to evaluate resource data. At act 1505, the facility uses the snapshot of the resource graph to generate the resource graph at the time the snapshot was taken and the attribute data to evaluate the resource data. After act 1505, the process to create and use a snapshot of a resource graph ends.

The facility may perform the process to create and use a snapshot of a resource graph 1500 to simulate previous versions of resource graphs based on previous resource attribute data, attributes, and attribute relationships. Thus, the facility is able to use the simulated graphs for multiple purposes, such as accurately auditing an organizations resource data based on past attributes, attribute relationships, and attribute data, allowing the facility to preserve the context of the resource data at the time it was evaluated.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. One or more instances of computer-readable media collectively having contents configured to cause a computing device to perform a method for creating resource graphs, the method comprising:
obtaining user input specifying one or more inherent resource attributes;
obtaining user input specifying one or more derived resources and their relationships to other resource attributes;
generating a resource graph based on the one or more derived resource attributes, the one or more inherent resource attributes, and the one or more relationships to other resource attributes;
obtaining attribute data from a repository of resource attribute data for a resource represented by the resource graph; and
using the resource graph and the attribute data to evaluate resource data.

2. The one or more instances of computer-readable media of claim 1, wherein the method further comprises:
obtaining data specifying a value for a resource attribute;
updating the resource attribute to include the obtained data; and
using the resource graph, the attribute data, and the obtained data to evaluate the resource data.

3. The one or more instances of computer-readable media of claim 1, wherein the method further comprises:
obtaining data specifying a value for a resource attribute;
updating the resource attribute to include the obtained data;
receiving an indication that the resource data should be evaluated; and
in response to receiving the indication that the resource data should be evaluated, using the resource graph, the attribute data, and the obtained data to evaluate the resource data.

4. The one or more instances of computer-readable media of claim 1, wherein the method further comprises:
receiving a request for resource attribute data; and
using the resource graph and the attribute data to evaluate the resource data to obtain the requested resource attribute data.

5. The one or more instances of computer-readable media of claim 1, wherein the method further comprises:
receiving a request for resource attribute data;
determining which of the one or more inherent resource attributes and one or more derived attributes are required to obtain the requested resource attribute data based on the resource graph; and
using the resource graph and attribute data to evaluate the resource data, such that only the one or more inherent resource attributes and one or more derived attributes are evaluated to obtain the requested resource attribute data.

6. The one or more instances of computer-readable media of claim 1, wherein the resource graph further comprises tags for a resource represented by the resource graph, and wherein the tags are used to evaluate the resource data.

7. The one or more instances of computer-readable media of claim 6, further comprising:
obtaining an indication that an attribute of the resource represented by the resource graph is to be aggregated with one or more attributes of other resources;
obtaining an indication of one or more tags used to identify resources to be aggregated;
identifying an aggregation function to be used to aggregate the attribute of the resource with the one or more attributes of other resources; and
aggregating the attribute of the resource with the one or more attributes of other resources based on the aggregation function and the one or more tags used to identify resources to be aggregated.

8. The one or more instances of computer-readable media of claim 1, further comprising generating a snapshot of the resource graph.

9. The one or more instances of computer-readable media of claim 8, further comprising:
receiving a request that a snapshot of the resource graph should be used to evaluate the resource data; and
using the snapshot of the resource graph and the attribute data to evaluate the resource data.

10. The one or more instances of computer-readable media of claim 8, further comprising:
receiving an indication that a value history of one or more attributes should be used to evaluate the resource data, wherein the snapshot further comprises the value history; and
using the value history of the one or more attributes and the resource graph to evaluate the resource data.

11. One or more storage devices collectively storing a resource graph data structure, the data structure comprising:
information specifying one or more inherent resource attributes;
information specifying one or more derived resource attributes and their relationships to other resource attributes;
information specifying one or more relationships among inherent and derived resource attributes; and
information specifying a source of resource attribute data,
such that the contents of the data structure are usable by a computing device to use a resource graph represented in the data structure's contents to evaluate resource data.

12. The one or more storage devices of claim 11, the data structure further comprising:
information specifying one or more resource tags,
such that the information specifying one or more resource tags are usable by a computing device to obtain resources with similar tags for aggregating resource data.

13. The one or more storage devices of claim 11, the data structure further comprising:
information specifying one or more resource graph snapshots,
such that the information specifying one or more resource graph snapshots are usable by a computing device to evaluate a prior state of the resource graph represented in the data structure's contents to evaluate the resource attribute data.

14. A system for creating resource graphs, the system comprising:
a computing device configured to generate resource graphs;
the computing device being further configured to:
obtain user input specifying one or more inherent resource attributes;
obtain user input specifying one or more derived resources and their relationships to other resource attributes;
generate a resource graph based on the one or more derived resource attributes, the one or more inherent resource attributes, and the one or more relationships to other resource attributes;
obtain attribute data from a repository of resource attribute data for a resource represented by the resource graph; and
use the resource graph and attribute data to evaluate the resource data.

15. The system of claim 14, wherein the computing device is further configured to:
obtain data specifying a value for a resource attribute;
update the resource attribute to include the obtained data; and
use the resource graph, attribute data, and the obtained data to evaluate resource data.

16. The system of claim 14, wherein the computing device is further configured to:
obtain data specifying a value for a resource attribute;
update the resource attribute to include the obtained data;
receive an indication that the resource data should be evaluated; and
in response to receiving the indication that the resource data should be evaluated, using the resource the resource graph, the attribute data, and the obtained data to evaluate the resource data.

17. The system of claim 14, wherein the computing device is further configured to:
receive a request for resource attribute data; and
use the resource graph and the attribute data to evaluate the resource data to obtain the requested resource attribute data.

18. The system of claim 14, wherein the computing device is further configured to:
receive a request for resource attribute data;
determine which of the one or more inherent resource attributes and one or more derived attributes are required to obtain the requested resource attribute data based on the resource graph; and
use the resource graph and attribute data to evaluate the resource data, such that only the one or more inherent resource attributes and one or more derived attributes are evaluated to obtain the requested resource attribute data.

19. The system of claim 14, wherein the resource graph further comprises tags for a resource represented by the resource graph, wherein the tags are used to evaluate the resource data.

20. The system of claim 19, wherein the computing device is further configured to:
receive a request that an attribute of the resource represented by the resource graph is to be aggregated with one or more attributes of other resources;
obtain an indication of one or more tags used to identify resources to be aggregated;
identify an aggregation function to be used to aggregate the attribute of the resource with the one or more attributes of other resources; and
aggregate the attribute of the resource with the one or more attributes of other resources based on the aggregation function and the one or more tags used to identify resources to be aggregated.

21. The system of claim 14, wherein the computing device is further configured to generate a snapshot of the resource graph.

22. The system of claim 21, wherein the computing device is further configured to:
obtain an indication that a snapshot of the resource graph should be used to evaluate the resource data; and
use the snapshot of the resource graph and the attribute data to evaluate the resource data.

23. The system of claim 21, wherein the computing device is further configured to:
obtain an indication that a value history of one or more attributes should be used to evaluate the resource data, wherein the snapshot further comprises the value history; and
use the value history of the one or more attributes and the resource graph to evaluate the resource data.
